(19) United States
(12) Patent Application Publication
(10) Pub. No.: US 2025/0138497 A1
(43) Pub. Date: May 1, 2025

(54) BUILDING ENERGY MANAGEMENT SYSTEM AND METHOD FOR MANAGING ENERGY WITHIN BUILDINGS

(71) Applicant: Ryan O'Leary, Warwick, NY (US)

(72) Inventor: Ryan O'Leary, Warwick, NY (US)

(73) Assignee: OZOP ENERGY SYSTEMS, INC., Warwick, NY (US)

(21) Appl. No.: 18/923,574

(22) Filed: Oct. 22, 2024

Related U.S. Application Data
(60) Provisional application No. 63/545,808, filed on Oct. 26, 2023.

(51) Int. Cl. G05B 15/02

(52) U.S. Cl. CPC G05B 15/02

(57) ABSTRACT

Disclosed is a building energy management system (BEMS) for a building comprising a plurality of individual units. Each individual unit comprises a first light detector to detect a first indoor light level for each individual unit and a first occupancy sensor to determine a first occupancy level within the individual unit. The BEMS comprises a control module connected to each first light detector, the plurality of first light appliances and each first occupancy sensor. The control module scans to determine a list of all the first light appliances within each individual unit to create a map of the first light appliances, groups the mapped first light appliances into a plurality of clusters, assigns control parameters to each cluster and controls the clustered first light appliances based on detected light and occupancy levels.

### CROSS-REFERENCE TO RELATED APPLICATIONS/INCORPORATION BY REFERENCE

This application claims priority to U.S. provisional application 63/545,808 titled “Controlled Power Supply in Building Energy Management System (BEMS),” filed on Oct. 26, 2023, which is incorporated herein by reference in its entirety for all purposes.

### FIELD OF THE INVENTION

Generally, the present disclosure relates to building energy management systems. Particularly, the present disclosure relates to a building energy management system for a building comprising a plurality of individual units.

### BACKGROUND

The background description includes information that may be useful in understanding the present invention. It is not an admission that any of the information provided herein is prior art or relevant to the presently claimed invention, or that any publication specifically or implicitly referenced is prior art.

Electrical energy has become an indispensable component of modern infrastructure. Electrical energy provides necessary power for residential, commercial and industrial sectors globally. The increase in global electricity consumption creates significant pressure on existing energy resources. Consequently, as demand grows, electrical energy requires efficient management to mitigate risks associated with energy waste. Such risks lead to environmental damage and depletion of finite resources because inefficient energy usage directly contributes to greenhouse gas emissions. Greenhouse gas emissions serve as a major factor in climate change. Further, the control and optimisation of energy consumption have become a priority to ensure sustainability.

The residential and commercial sectors consume a substantial proportion of the global energy supply. Traditionally, energy management systems in such sectors have been limited in functionality. Such systems generally provide basic data on overall energy consumption without real-time insights or advanced analytics. Conventional systems lack the ability to analyse usage patterns at a granular level, such as by individual appliances or areas of a building. Additionally, conventional systems do not offer actionable insights or recommendations for improving energy efficiency. Consequently, such systems lead to continued wastage of electricity. The wastage results in higher costs and failure to take advantage of energy-saving measures.

The introduction of smart energy management systems (SEMS) represents a significant advancement in energy optimisation. SEMS enable detailed and real-time monitoring of energy usage. Additionally, SEMS offer advanced control and automation features. SEMS technology comprises a range of sensors and data analytics to optimise the operation of HVAC systems, lighting and other energy-consuming equipment. Further, SEMS monitor consumption at an appliance level. SEMS employ machine learning algorithms to identify inefficiencies in real-time. Such algorithms enable SEMS to automate energy-saving measures. Moreover, SEMS contribute to energy conservation and reduction of greenhouse gas emissions.

However, despite the benefits offered by SEMS, conventional systems still face limitations. Such limitations comprise high initial costs, difficulties in integrating with existing building infrastructure and technical complexity. Such limitations often hinder the widespread adoption of SEMS. Further, seamless integration with established Building Management Systems (BMS) is necessary for coherent and effective energy management, particularly in older buildings. Additionally, the need for BMSs capable of adapting to changing building requirements remains unmet.

In light of the above discussion, an urgent need exists for solutions to overcome the problems associated with conventional energy management systems. Such problems relate to the efficient control of lighting and other energy-consuming devices in response to real-time conditions and occupancy levels.

### SUMMARY

The following Summary section provides only a brief introduction to the various embodiments of the present invention. It is to be understood that the following paragraphs are neither meant to constitute a complete and thorough description of the claimed subject matter nor is it intended to define the technical features or the scope of the claimed subject matter. Thus, the description in the Summary section is neither intended to identify only the essential features of the present invention nor limit the scope of the claimed subject matter in any manner.

Generally, the present disclosure relates to building energy management systems. Particularly, the present disclosure relates to a building energy management system for a building comprising a plurality of individual units.

In an aspect, the present disclosure provides a building energy management system (BEMS) for a building comprising a plurality of individual units. Each individual unit comprises a first light detector to detect a first indoor light level associated with light emitted from a plurality of first light appliances arranged within the unit and a first occupancy sensor to determine a first occupancy level within the unit. The BEMS comprises a control module connected to each first light detector, the plurality of first light appliances and each first occupancy sensor. The control module scans to determine a list of all first light appliances to create a map, groups the mapped appliances into clusters based on predefined criteria, assigns control parameters to each cluster and receives the detected light level and determined occupancy level for each unit. The control module compares the determined occupancy level with a first occupancy threshold to identify a first set of units having an occupancy level lower than the threshold. Further, the control module compares the detected light level with a first indoor light threshold to identify a second set of units with detected light levels exceeding the threshold. The control module controls by reducing the electrical power supplied to the clustered light appliances within the second set of units according to the assigned control parameters. The BEMS enables efficient energy management in individual units by adjusting lighting based on real-time occupancy and lighting levels, reducing unnecessary power consumption.

In an embodiment, the BEMS enables energy management for common areas and an outdoor space. Each common area and outdoor space comprise a second light detector to detect light intensity from second light fixtures and a second occupancy sensor to determine the occupancy status of each area. The control module scans to identify all second light fixtures, groups the second light fixtures into categories based on preset parameters and assigns operational settings to each category. The control module receives the detected light intensity and occupancy status, compares the occupancy status with a second threshold to identify common areas and outdoor spaces having occupancy levels below the threshold and compares the light intensity with a second threshold to identify areas where the light intensity exceeds the threshold. The control module then controls by reducing the electrical power supplied to the second light fixtures according to the assigned operational settings. Such a configuration enables optimized lighting control across common areas and outdoor spaces, enhancing overall building energy efficiency while maintaining adequate lighting levels based on actual usage.

In another embodiment, the BEMS automatically sorts added or removed second light detectors, second light appliances and second occupancy sensors based on device type, internet protocol (IP) address, device name, or device status. Such functionality enables streamlined management of devices within the BEMS, ensuring that updates and changes to the lighting infrastructure are processed without manual intervention.

In another embodiment, each first light detector within the BEMS is implemented using a photocell array. Such an arrangement enables accurate detection of light levels within individual units, improving the precision of lighting adjustments.

In another embodiment, each second light detector is implemented using a second photocell array. The use of a photocell array for second light detectors ensures reliable measurement of light intensity within common areas and outdoor spaces, contributing to more efficient lighting control.

In a further embodiment, each first light appliance within the BEMS is connected to a dimming driver. The control module controls each first dimming driver individually to alter the electrical power supplied to each light appliance. Such a control mechanism enables precise adjustments to the lighting, minimizing power consumption while maintaining desired lighting conditions.

In another embodiment, each second light appliance is connected to a second dimming driver and the control module individually controls each second dimming driver to adjust power. Such an operation allows for flexible and dynamic lighting control in common areas and outdoor spaces, reducing energy consumption based on occupancy and lighting needs.

In another embodiment, the BEMS comprises a memory to store operational information about each first and second light appliance, including historical data related to the power supplied to the appliances. The memory enables tracking and analysis of power usage patterns, facilitating further optimization of the system's energy management.

In another embodiment, the memory stores scheduling information, comprising command data for increasing or decreasing power at specific times. The inclusion of scheduling information enables pre-programmed adjustments to lighting, contributing to a more structured approach to energy conservation.

In yet another embodiment, the memory holds functionality data, including failure information for the light appliances. The storage of failure information ensures that maintenance can be scheduled promptly, minimizing downtime and ensuring the reliable operation of the lighting system.

In another embodiment, the BEMS comprises input units connected to the control module, with each input unit receiving user inputs for modifying the behaviour settings of the light appliances. The inclusion of input units enables user customization of lighting settings, enhancing the flexibility and adaptability of the system in accordance with user preferences and operational requirements.

In another aspect, the BEMS implements a method for managing energy within a building comprising a plurality of individual units. Each unit comprises a plurality of first light appliances. The method comprises detecting, using a first light detector, a first indoor light level corresponding to the light emitted by the plurality of first light appliances in each unit and determining, using a first occupancy sensor, a first occupancy level within each unit. The control module scans the plurality of first light appliances in each unit to generate a list of the appliances, creating a map. The mapped appliances are then grouped into clusters based on predefined criteria and control parameters are assigned to each cluster. The control module receives the detected light level and the determined occupancy level, compares the occupancy level to a threshold to identify units with lower occupancy and further compares the detected light level with a light threshold. The control module identifies a set of units with higher light levels and reduces the electrical power supplied to the light appliances within these units according to the assigned control parameters. The method enables an automated approach to energy management, reducing electrical consumption in units with low occupancy and excessive lighting levels.

In an embodiment, the control parameters assigned to each cluster of the mapped first light appliances are dynamically adjusted based on factors such as outdoor light level, weather conditions, instant time and power consumption. Such dynamic adjustment enables real-time energy optimization by considering environmental and operational conditions, further improving energy efficiency within the building.

In another embodiment, the control module adjusts the electrical power supplied to the clustered first light appliances based on current electricity rates. Such an adjustment of the supplied electrical power enables cost-effective energy management by reducing power consumption during peak electricity pricing periods.

In another embodiment, the first light appliances within each cluster are categorized based on parameters such as light source type, energy rating, power consumption, fixture type, and light output. Such categorization enables the system to fine-tune control strategies for different types of light appliances, further enhancing energy savings.

In yet another aspect, the disclosure provides a non-transitory computer-readable storage medium comprising executable instructions that, when executed by a processing system including a processor, perform the energy management method. The method comprises detecting the first indoor light level, determining the occupancy level, scanning the first light appliances, grouping the appliances into clusters, assigning control parameters, receiving the detected light and occupancy levels, comparing them with respective thresholds and reducing the electrical power supplied to the appliances accordingly. The method implemented on such a medium ensures that energy management is carried out effectively, reducing energy waste and improving building sustainability.

The various objects, features and advantages of the claimed invention will become clear when reading the following Detailed Description along with the Drawings.

### BRIEF DESCRIPTION OF THE DRAWINGS

The following Brief Description of Drawings section will be better understood when read in conjunction with the appended drawings. Although exemplary embodiments of the present invention are illustrated in the drawings, the embodiments are not limited to the specific features shown in the drawings. The drawings illustrate simplified views of the claimed invention and are therefore, not made to scale. Identical numbers in the drawings indicate like elements in the drawings.

The embodiments of the present invention will now be briefly described by way of example only with reference to the drawings in which:

FIG. 1 shows a schematic illustration of a building energy management system (BEMS) for building, in accordance with an embodiment of the present disclosure;

FIG. 2 shows a schematic illustration of a building energy management system (BEMS), in accordance with an embodiment of the present disclosure;

FIG. 3 shows a schematic illustration of a building energy management system (BEMS), in accordance with an embodiment of the present disclosure;

FIG. 4 shows a schematic illustration of a building energy management system (BEMS), in accordance with an embodiment of the present disclosure; and

FIG. 5 shows a flowchart of a method for managing energy within a building comprising a plurality of individual units, in accordance with an embodiment of the present disclosure.

### DETAILED DESCRIPTION

The following is a detailed description of exemplary embodiments to illustrate the principles of the invention. The embodiments are provided to illustrate aspects of the invention, but the invention is not limited to any single embodiment. The scope of the invention encompasses without limitation numerous alternatives, modifications and combinations.

It shall be noted that as used within the current section as well as in the appended claims, the singular forms “a”, “an” and “the” comprise plural referents unless the context clearly dictates otherwise. Further, the use of words such as “first”, “second”, “third” and the like does not represent any particular order. Such words have been merely employed to distinguish one individual component from another. Moreover, “each” refers to each member of a set or each member of a subset of a set.

An arrangement of two or more components, unless stated specifically, can be done without limitation in any manner relative to a three-dimensional coordinate system. Thus, a second component arranged underneath a first component may also be taken to mean that the first component is arranged underneath the second component.

It will also be appreciated that modifications, additions, or omissions may be made to the systems and apparatuses described hereinafter without departing from the scope of the Claims. The components of the systems and apparatuses may be integrated or separated. Moreover, the operations of the systems and apparatuses may be performed by more, fewer, or other components.

The present disclosure relates to building energy management systems. Particularly, the present disclosure relates to a building energy management system for a building comprising a plurality of individual units.

The term “building energy management system” (BEMS) 100 refers to a centralized or decentralized system for monitoring, controlling, and optimizing energy consumption within a structure. The BEMS 100 integrates sensors, control units, and software to manage energy efficiently. The BEMS often targets areas such as lighting, heating, ventilation, and air conditioning. The BEMS 100 tracks real-time data pertaining to energy usage, thereby improves energy efficiency and reduces operational costs. The BEMS 100 operates by interacting with various components such as sensors, appliances, and controllers. Additionally, the BEMS 100 allows for dynamic adjustments based on occupancy, time of day, and the like.

The term “building” 102 refers to any structure that contains multiple enclosed areas or units, where energy is consumed. Building 102 ranges from residential complexes to commercial office spaces. Building 102 can comprise industrial facilities or temporary structures such as domes, tents, and exhibition halls. Additionally, building 102 can comprise open arenas such as stadiums, parking lots, or amphitheatres. Such building 102 consumes energy for lighting, sound systems, or other utilities. Further, systems and appliances work together in building 102 to control internal environments such as lighting, heating, and ventilation. Building 102 often comprises interconnected systems to manage energy usage, comfort, and safety. Central management systems typically monitor and control energy usage within building 102 to enhance efficiency and reduce costs.

The term “individual units” 104A-B refers to separate autonomous spaces within a building 102. Such individual units 104A-B function independently in terms of energy consumption and control. Each unit comprises devices such as lighting, heating, or air conditioning systems. Such individual units 104A-B are managed separately and allow customized settings for each space based on specific needs. Individual units 104A-B contribute to a building 102 wide energy management strategy.

The term “light detector” refers to a sensor to sense/measure the intensity of light within an indoor environment. A photosensitive element of the light detector captures light and generates a signal. Such signal is processed to determine the current light levels, including natural and artificial sources. The light detector compares the measured light against predefined thresholds. When natural light increases, the light detector signals the system to reduce artificial lighting output. When light levels fall below the desired threshold, the detector triggers an increase in artificial lighting. Such a dynamic adjustment ensures that lighting systems only use energy when necessary.

The term “indoor light level” refers to measured brightness within an indoor space. Indoor light levels are typically influenced by both natural and artificial light sources. Monitoring indoor light levels helps maintain adequate visibility. Further, the data collected from such light levels optimizes energy usage. Additionally, such data automatically adjusts the lighting arrangement. Such monitoring ensures that spaces are well-lit without unnecessary energy consumption. Balanced light levels in office buildings or homes improve comfort and productivity. Additionally, maintaining such balanced light levels reduces utility costs.

The term “light appliances” refers to devices that emit artificial light such as LED bulbs or fluorescent tubes. Such appliances are essential in residential, commercial, and industrial settings. Light appliances can be managed individually. Light appliances can also be managed as part of a larger system. Such a system optimizes energy consumption based on environmental factors like occupancy or natural light availability.

The term “occupancy level” refers to the number of individuals present in a specific area or unit at any given time. Occupancy levels can vary dynamically based on factors such as space size, area purpose, or time of day.

The term “control module” 112 refers to the central unit within an automated system that processes data from sensors and devices. The control module 112 receives input from sensors and issues commands to optimize energy consumption.

The term “map” refers to a virtual representation or diagram generated by a system to display the layout and distribution of devices, appliances, or other elements within a defined space. The map illustrates the location and status of components such as lighting, HVAC systems, or sensors. Additionally, the map provides an overview of how energy-consuming devices are distributed across a building 102. The virtual map enables systems to group devices into clusters or zones.

The term “control parameters” refers to predefined rules or settings that dictate how devices or systems operate. Such control parameters comprise temperature setpoints, lighting levels, or occupancy thresholds. Further, such parameters manage energy consumption.

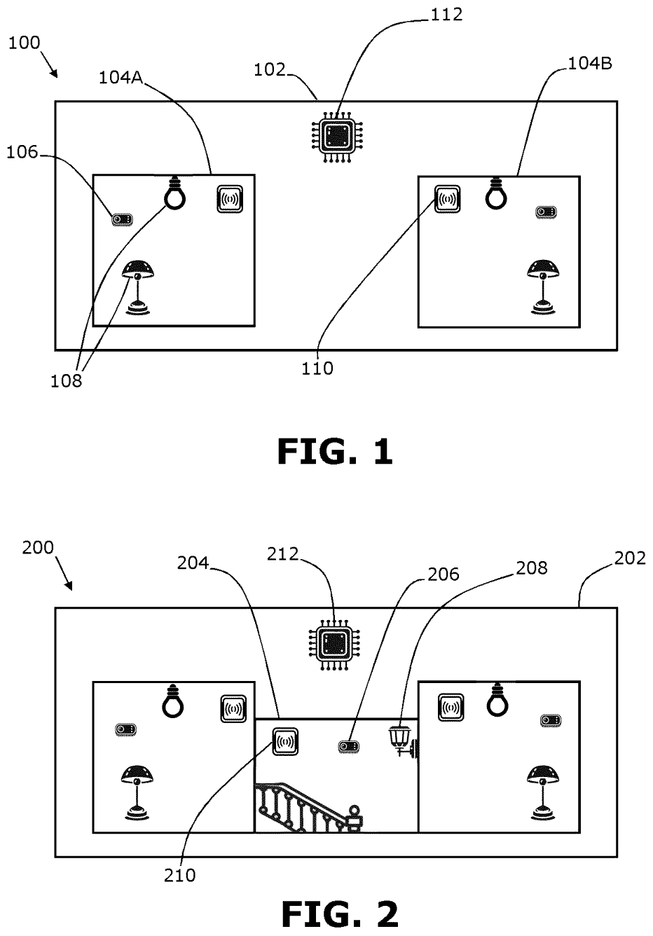

Referring to FIG. 1, a schematic illustration of a building energy management system (BEMS) 100 for building 102 is shown, in accordance with an embodiment of the present disclosure. The building 102 comprises a plurality of individual units 104A-B. The building 102 can be a commercial building, such as an office building, an apartment complex, a hostel, a hotel, a shopping mall, a factory or a hospital.

Each individual unit 104A-B can be physically separated spaces, like flats or rooms, or virtually separated spaces, such as work areas in an open-plan office. Each individual unit 104A-B comprises a first light detector 106 to detect a first indoor light level for the respective individual unit 104A-B. The first indoor light level is associated with light emitted from a plurality of first light appliances 108 arranged within the individual unit 104A-B. The plurality of light appliances 108 comprises ceiling lights, task lights and other sources of illumination inside the individual unit 104A-B, such as light from electronic devices. The first light detector 106 is positioned within the individual unit 104A-B to measure overall lighting conditions.

Additionally, each individual unit 104A-B comprises a first occupancy sensor 110 to determine a first occupancy level for the respective individual unit 104A-B. The number of occupants varies with time. For example, employees arrive and leave a work area in an office, or guests check in and out of a hotel room. Further, first occupancy sensor 110 detects changes in occupancy over specific time intervals, such as every minute, five minutes or hourly.

The BEMS 100 comprises a control module 112 connected to each first light detector 106, the plurality of first light appliances 108 and each first occupancy sensor 110. The control module 112 manages energy consumption by optimizing the operation of first light appliances 108 in response to detected light and occupancy conditions. The control module 112 scans and determines a list of all first light appliances 108 within each individual unit 104A-B to create a map of first light appliances 108. Such a map is essential for accurately tracking and controlling the system.

Further, the control module 112 groups the mapped first light appliances 108 into a plurality of clusters based on predefined criteria, such as location, light intensity requirements or the function of the space. For example, lighting near windows might be grouped separately from internal lighting. The control module 112 assigns control parameters to each cluster to facilitate energy-efficient operation based on occupancy and natural light levels.

The control module 112 receives the detected first indoor light level from first light detector 106 of each individual unit 104A-B and the determined first occupancy level for each individual unit 104A-B. The control module 112 subsequently compares the determined first occupancy level with a first occupancy threshold for each individual unit 104A-B to identify a first set of individual units having the determined first occupancy level lower than the first occupancy threshold. For example, in a residential building 102, the occupancy threshold for an apartment is set to 1, meaning the apartment is considered unoccupied if no resident is inside. In a commercial building 102, such as an office, the occupancy threshold is higher, such as 10, for large open-plan workspaces.

Further, once the control module 112 identifies the first set of individual units with low occupancy, the control module 112 compares the detected first indoor light level with a first indoor light threshold for each individual unit 104A-B of the first set to identify a second set of individual units where the detected first indoor light level is higher than the first indoor light threshold. The control module 112 controls the amount of electrical power supplied to clustered first light appliances 108 within each individual unit 104A-B of the second set by reducing power according to the assigned control parameters. For example, in an office with natural light entering through large windows, the BEMS 100 reduces power to overhead lighting if the indoor light level exceeds the threshold, even if occupancy is minimal.

In exemplary operation of the BEMS 100 within a residential apartment complex, each individual unit 104A-B corresponds to a separate apartment. The first light detector 106 in each apartment detects the overall light level from ceiling lights, desk lamps and light from televisions or other electronic appliances. The first occupancy sensor 110 detects whether the apartment is occupied. The control module 112 maps light appliances 108 and groups them into clusters, such as living room lighting and bedroom lighting. Thereafter, when the control module 112 detects an apartment as unoccupied by comparing the detected occupancy level to a threshold of 1, the control module 112 checks if the indoor light level exceeds the threshold due to lights being left on. Consequently, if lights are on in unoccupied apartments, the control module 112 reduces power to these lights, turning them off or dimming them to prevent unnecessary energy consumption.

In another exemplary operation of the BEMS 100 within an office building 102, the individual units 104A-B represent different office spaces or workstations. The first light detector 106 measures the light levels from overhead lighting and task lights, while first occupancy sensor 110 monitors how many employees are present in the office. The control module 112 groups lights in workspaces with abundant natural light separately from those in windowless areas. Subsequently, when the control module 112 detects that the occupancy in an office drops below a threshold of 10 indicating fewer employees than expected and the indoor light level exceeds the threshold, the control module 112 reduces the power supplied to overhead lights. Such an adjustment not only saves energy but also improves lighting comfort by adjusting brightness based on real-time conditions.

Consequently, the BEMS 100 provides a significant reduction in energy consumption by actively controlling lighting appliances based on real-time occupancy and light levels, ensuring efficient use of electrical power in both residential and commercial building 102.

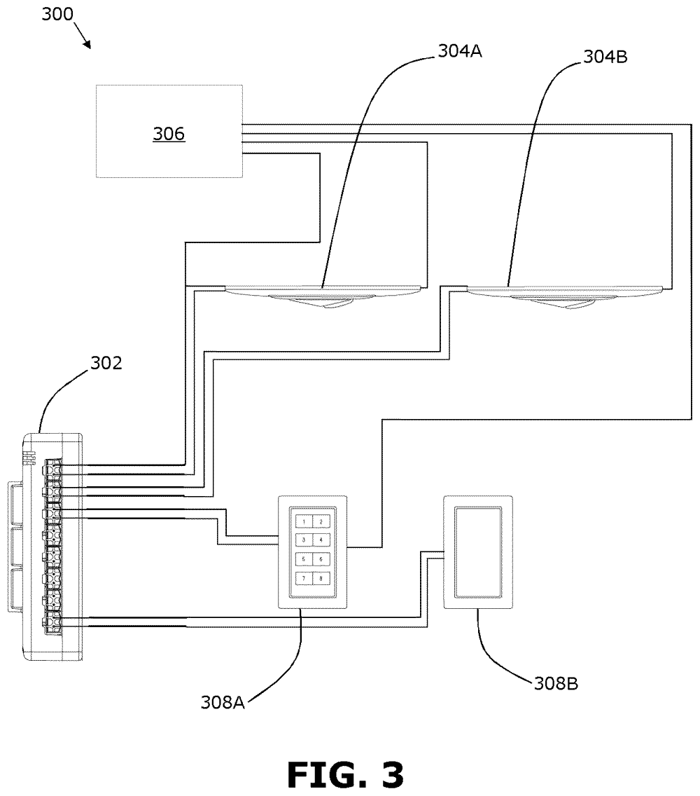

Referring to FIG. 2, a schematic illustration of a building energy management system (BEMS) 200 is shown, in accordance with an embodiment of the present disclosure. The BEMS 200 is implemented within a building 202 comprising a plurality of common areas and an outdoor space 204 in addition to individual units (such as individual units 104A-B from FIG. 1). The common areas and outdoor space 204 comprise locations such as hallways, lobbies, parking lots and courtyards. Each common area and the outdoor space 204 comprise a second light detector 206 configured to detect a second light intensity for the respective area. The second light intensity is associated with light emitted from a plurality of second light fixtures 208 arranged within each common area and the outdoor space 204. Further, such light fixtures comprise hallway lighting, lobby chandeliers or outdoor streetlights.

Additionally, each common area and the outdoor space 204 comprises a second occupancy sensor 210 to determine a second occupancy status for each common area and the outdoor space 204. The second occupancy status indicates the number of people present in the area at any given time. Further, such a status fluctuates depending on the use of the space. For example, hallways experience increased occupancy during specific times of day, while lobbies experience peaks during check-in or check-out times in a hotel.

The control module 212 (similar to the control module 112 of FIG. 1) is connected to each second light detector 206, the plurality of second light fixtures 208 and each second occupancy sensor 210. The control module 212 manages energy efficiency across common area and outdoor space 204 by optimizing lighting based on real-time data. The control module 212 scans to identify all second light fixtures 208 within each common area and outdoor space 204 to create an inventory of second light fixtures 208. Such an inventory ensures that all lighting points are accounted for and can be controlled effectively.

Further, the control module 212 groups the second light fixtures 208 into a plurality of categories based on preset parameters such as fixture type, location or lighting intensity. For example, lobby lighting is grouped separately from hallway lighting due to different functional and aesthetic requirements. The control module 212 assigns operational settings, such as brightness levels or time-based schedules, to each category of lighting.

Subsequent to categorization of the second light fixtures 208, the control module 212 receives the detected second light intensity from each second light detector 206 and the determined second occupancy status from each second occupancy sensor 210. The control module 212 compares the determined second occupancy status with a second occupancy threshold for each common area and outdoor space 204 to identify a primary set of common areas and outdoor spaces 204 with occupancy lower than the occupancy threshold. For example, in a hallway or hotel lobby, the occupancy threshold is set to 5, indicating that if fewer than 5 people are present, the area is considered under-occupied.

Further, once the control module 212 identifies the primary set of common areas and outdoor spaces 204 with low occupancy, the control module 212 compares the detected second light intensity with a second light threshold for each common area and outdoor space 204 within the primary set. Moreover, if the second light intensity exceeds the threshold, the control module 212 identifies a secondary set of common areas and outdoor spaces 204 where lighting levels are unnecessarily high. The control module 212 then adjusts the operation of second light fixtures 208 within the secondary set by reducing the power supplied to these fixtures, conserving energy.

In exemplary operation of the BEMS 200 within a residential apartment building 102, the hallway comprises second light fixtures 208 such as overhead lights that provide illumination along corridors. The second light detector 206 measures the light intensity in the hallway, while the second occupancy sensor 210 monitors the number of residents walking through the space. Further, during periods of low occupancy such as late at night, the second occupancy sensor 210 detects fewer than 2 people, which is lower than the predefined threshold of 2 occupants. The control module 212 identifies the hallway as part of the primary set of under-occupied common areas. Next, the control module 212 checks if the light intensity in the hallway exceeds the threshold of 300 lux due to lights being fully powered. Further, if the second light intensity is above the threshold, the control module 212 reduces the power supplied to the lights, dimming them to 50% of full brightness. Such adjustment prevents energy waste by adjusting lighting based on real-time occupancy while maintaining safety for late-night foot traffic.

In another exemplary operation of the BEMS 200 within a hotel, the lobby represents a common area that experiences varying levels of occupancy throughout the day. The lobby comprises second light fixtures 208 such as chandeliers, wall sconces and decorative lighting, all of which are managed by BEMS 200. The second occupancy sensor 210 in the lobby detects the number of guests and staff present. Further, during non-peak times such as mid-afternoon when few guests check in or out, the occupancy drops below the threshold of 5. The control module 212 categorizes lobby lighting based on fixture type and assigns operational settings, such as dimming schedules, for different times of day. Moreover, when the control module 212 detects that occupancy is low and second light intensity exceeds the threshold, such as due to bright chandeliers, the control module 212 reduces the power supplied to second light fixtures 208, lowering brightness by 30%. Such adjustment creates a relaxed atmosphere while conserving energy until occupancy rises again during busier hours, such as in the morning or evening.

In both the above examples, the BEMS 200 manages lighting in common areas and outdoor spaces 204 efficiently by dynamically adjusting lighting intensity according to real-time occupancy and environmental conditions. Further, such an approach improves energy efficiency and enhances user experience by providing appropriate lighting levels based on actual needs.

In an embodiment, the BEMS 200 automatically sorts added or removed second light detectors 206, second light appliances 208 and second occupancy sensors 210 based on device type, internet protocol (IP) address, device name or device status. Such a functionality enables streamlined management of devices within BEMS 200, ensuring updates and changes to the lighting infrastructure are processed without manual intervention. The control module 212, connected to each second light detector 206 and second light appliance 208, identifies newly introduced or removed devices within the system based on such parameters and integrates them into BEMS 200 or removes them from the system inventory. Such management enables seamless scalability of the BEMS 200 as more devices are introduced or removed over time.

In another embodiment, each first light detector 106 within BEMS 100 comprises a photocell array. The photocell array comprises a matrix of photocells arranged on a substrate. Such an arrangement enables accurate detection of the first indoor light level within each individual unit 104A-B. The control module 112 receives the light level detected by first light detector 106 and uses such information to adjust lighting in the respective unit based on predefined thresholds. Such precise detection allows finer control over first light appliances 108, thereby improving energy efficiency and ensuring lighting conditions remain optimal based on actual lighting requirements within each unit.

In another embodiment, each second light detector 206 located in common areas and outdoor spaces 204 comprises a second photocell array. Similar to the implementation in individual units 104A-B, such a second photocell array enhances BEMS 200 by providing accurate measurements of second light intensity in larger and more open spaces, such as lobbies, hallways or outdoor environments. Such arrays ensure control module 212 efficiently manages second light fixtures 208, dynamically adjusting power output based on the real-time light intensity detected by the photocell arrays. Consequently, lighting in common areas and outdoor spaces 204 remains energy efficient and responsive to changing conditions, such as daylight levels.

Further, in another embodiment, each first light appliance 108 within BEMS 100 connects to a first dimming driver (not separately illustrated). The control module 112 individually controls each first dimming driver to alter the electrical power supplied to each first light appliance 108. Such a setup enables BEMS 100 to finely adjust the brightness of each light fixture within individual units 104A-B. Such an operation reduces power consumption during times when full lighting is not required, such as when the occupancy level is low or when sufficient ambient light is available. Additionally, individualized control over first dimming drivers allows for more granular energy management, leading to further reductions in electrical usage while maintaining comfortable lighting conditions.

In another embodiment, each second light appliance 208 located in common areas and outdoor spaces 204 connects to a second dimming driver (not separately illustrated). The control module 212 individually controls each second dimming driver. Further, the BEMS 100 provides flexible and dynamic lighting control over common areas and outdoor spaces 204 by adjusting lighting based on the second occupancy status and second light intensity detected by second light detectors 206. For example, during periods of low occupancy in a hotel lobby, the control module 212 reduces the brightness of lobby lights to conserve energy while ensuring lighting remains adequate for safety and functionality.

In another embodiment, the BEMS 100 comprises a memory configured to store operational information about each first light appliance 108 and second light appliance 208, including historical data related to the amount of electrical power supplied to such appliances. Such operational information enables the control module 112 or 212 to analyse power usage patterns over time, allowing further optimization of energy management strategies based on historical trends. For example, the BEMS 100 could analyse periods of low occupancy in an office building 102 and adjust future lighting schedules accordingly to reduce unnecessary power consumption during off-peak hours.

In another embodiment, the memory stores scheduling information associated with each first light appliance 108 and second light appliance 208. The scheduling information comprises command data instructing control module 112 or 212 to increase or decrease the electrical power supplied to light appliances at specific times. Such pre-programmed functionality allows the BEMS 100 to automatically adjust lighting levels based on predetermined schedules. For example, the BEMS 100 dims lights in office spaces at the end of the workday or reduces lighting in outdoor areas during daylight hours. Consequently, by utilizing scheduling information, the BEMS 100 ensures energy usage is minimized during periods when full lighting is not required.

In yet another embodiment, memory stores functionality data, including failure information related to first light appliances 108 and second light appliances 208. Such failure information comprises data such as the time of failure, frequency of failure and the position of faulty light appliances. Thus, by maintaining a record of such failures, the BEMS 100 enables timely and efficient maintenance of the lighting system, ensuring malfunctioning or underperforming light fixtures are quickly identified and serviced. Such maintenance reduces downtime and ensures the lighting system operates reliably over time, improving the overall performance of the BEMS 100.

In another embodiment, the BEMS 100 comprises a plurality of input units communicably connected to control module 112 or 212. Each input unit receives user inputs for modifying behaviour settings associated with the plurality of first light appliances 108 and second light appliances 208. For example, a building manager may use the input unit to adjust brightness settings for specific rooms or common areas or change lighting schedules based on operational needs of the building 102. Further, the input units comprise graphical user interfaces (GUI) accessible from various devices, such as smartphones, tablets or desktop computers, allowing convenient and remote control over the lighting system. Such flexibility enhances the adaptability of the BEMS 100, enabling rapid response to changing user preferences or operational requirements.

Referring to FIG. 3, a schematic illustration of a building energy management system (BEMS) 300 is shown, in accordance with an embodiment of the present disclosure. The BEMS 300 manages and controls lighting within a building 102 comprising a plurality of individual units 104A-B and common areas. Further, the BEMS 300 integrates multiple components, including occupancy sensors, light detectors, light appliances and control interfaces, all operably connected to a control module 302.

As shown, the BEMS 300 comprises occupancy sensors 304A-B to detect occupancy levels within the controlled space. Each occupancy sensor 304A-B connects to the control module 302 through shared wiring. Further, a power supply 306 energizes the BEMS 300, with neutral and active power lines shown supplying power to control elements and sensors.

Additionally, the BEMS 300 comprises multiple control interfaces 308A-B that represent input units 104A-B connected to the control module 302. Such input units 104A-B receive user inputs to modify operational settings of light appliances, such as turning them on or off, dimming them or altering their schedules. Such control interfaces 308A-B connect to the control module 302, enabling direct user interaction with the lighting system.

Further, wiring connections are shown between the control module 302 and the occupancy sensors 304A-B, facilitating communication between the occupancy sensors 304A-B and the control module 302. The control module 302 receives data from the occupancy sensors 304A-B and adjusts the power supplied to connected light appliances based on occupancy status within the controlled area. Additionally, the BEMS 300 shows power line connections to each occupancy sensor 304A-B and the control interfaces 308A-B, ensuring proper operation of the BEMS 300.

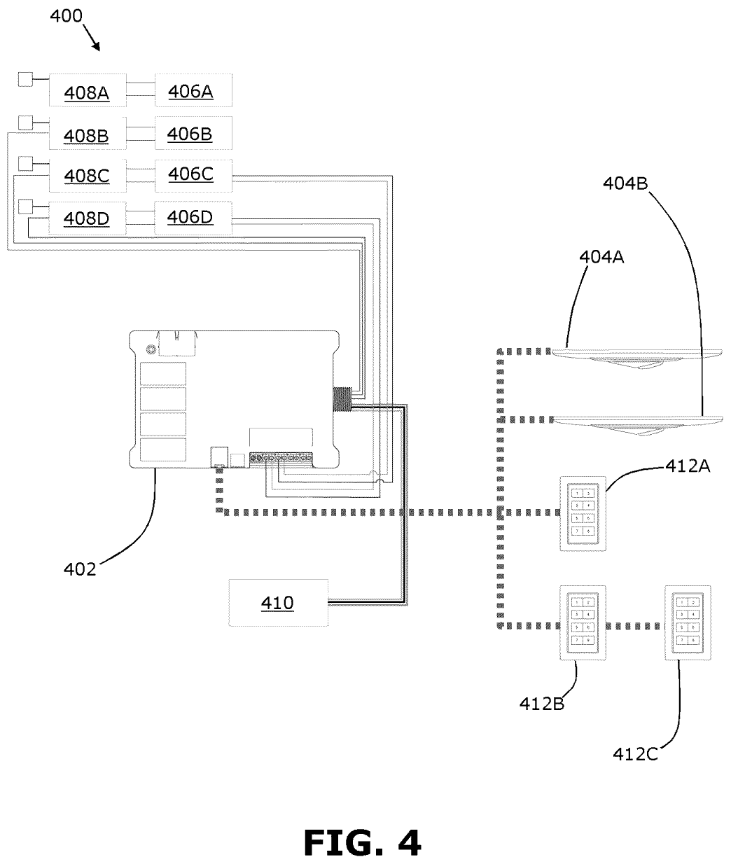

Referring to FIG. 4, a schematic illustration of a building energy management system (BEMS) 400 is shown, in accordance with an embodiment of the present disclosure. The BEMS 400 integrates multiple components to control lighting systems within a building environment, utilizing a centralized control module 402 interfacing with occupancy sensors 404A-B, light detectors 406A-D and light appliances 408A-D across multiple zones.

The BEMS 400 comprises several light appliances 418A-D connected to the control module 402 through separate wiring pathways. The control module 402 manages each light appliance, adjusting electrical power supplied to each based on real-time data gathered from connected occupancy sensors 404A-B via a light distribution panel 410. Such sensors comprise occupancy sensors 404A-B that are responsible for determining occupancy levels in specific zones.

Further, the BEMS 400 comprises a plurality of user input interfaces 412A-C connected to the control module 402. Such interfaces 412A-C allow building occupants or facility managers to modify behaviour settings of light appliances 408A-D, such as adjusting brightness or scheduling operational times. Additionally, wiring connections between input interfaces 412A-C and the control module 402 relay user inputs to the central system, allowing real-time adjustments to lighting configurations.

The BEMS 400 is configured with various wiring pathways, including connections between the control module 402 and occupancy sensors 404A-B. Such connections ensure that the BEMS 400 receives accurate data on building occupancy. Further, the control module 402 processes such data and adjusts power supplied to connected light appliances accordingly. Additionally, the BEMS 400 manages multiple zones, as indicated by distinct connections between various components.

Thus, the BEMS 400 provides a comprehensive solution for managing energy efficiency within a building 102 by dynamically adjusting lighting levels based on occupancy and other relevant factors.

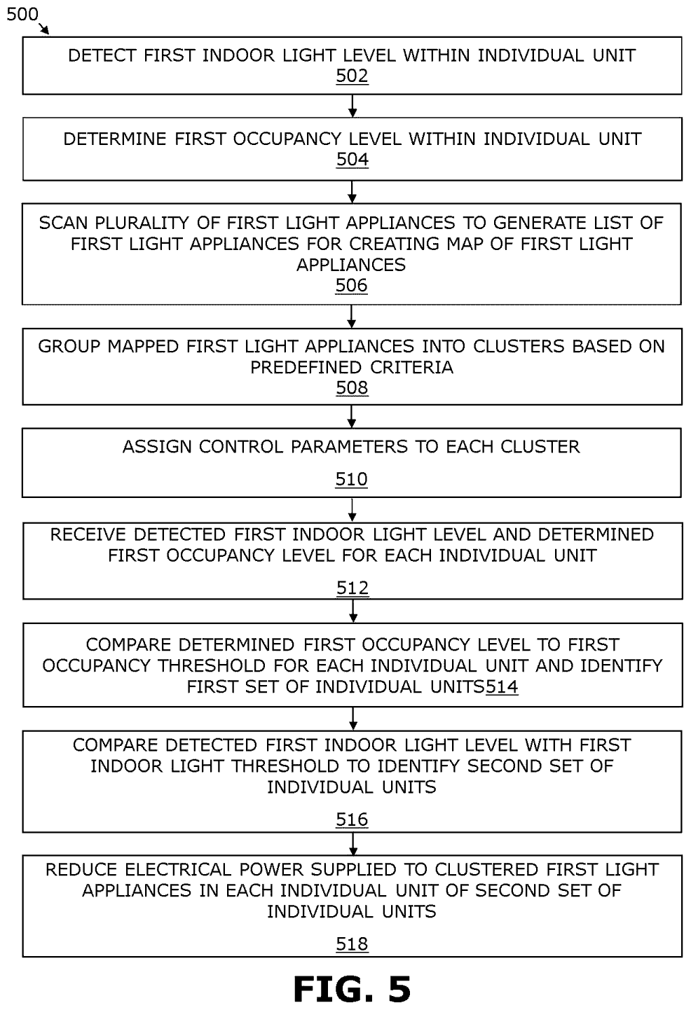

Referring to FIG. 5, a flowchart 500 of a method for managing energy within a building 102 comprising a plurality of individual units 104A-B is shown, in accordance with an embodiment of the present disclosure. Each individual unit comprises a plurality of first light appliances 108. At step 502, the method begins by detecting a first indoor light level using a first light detector 106 in each individual unit. The detected first indoor light level corresponds to light emitted by the plurality of first light appliances 108 arranged within the individual unit. Further, the first light detector 106 captures overall lighting conditions, including ambient light that may influence the indoor lighting level.

At step 504, a first occupancy level within the individual unit is determined using a first occupancy sensor 110. The first occupancy sensor 110 monitors the presence and number of occupants within each individual unit and generates data corresponding to the first occupancy level. Such data is updated over predetermined intervals.

At step 506, the plurality of first light appliances 108 in each individual unit is scanned using a control module 112. The control module 112 generates a list of the first light appliances 108, which are mapped to create a digital or visual representation of the lighting layout within each unit. Such mapping allows the control module 112 to manage and control individual or grouped lighting devices effectively.

At step 508, the mapped first light appliances 108 are grouped into clusters based on predefined criteria such as location, function or lighting needs within the unit. For example, light appliances in common areas like living rooms may be grouped separately from those in bedrooms or workspaces. Such clustering enables more efficient control by allowing the control module 112 to manage multiple appliances with similar characteristics collectively.

At step 510, control parameters are assigned to each cluster of the mapped first light appliances 108. Such control parameters can comprise dimming levels, power thresholds or time-based schedules for turning the appliances on or off. Assigning such control parameters enables the system to fine-tune lighting according to real-time conditions, such as occupancy and indoor light levels.

At step 512, the control module 112 receives the detected first indoor light level from each first light detector 106 and the determined first occupancy level from each first occupancy sensor 110 for each individual unit. The control module 112 processes such information to dynamically adjust the lighting and power supply 306 based on real-time data.

At step 514, the control module 112 compares the determined first occupancy level for each individual unit to a first occupancy threshold. Such a threshold defines the minimum number of occupants necessary for normal lighting operation. Further, the control module 112 identifies a first set of individual units where the occupancy level falls below the first occupancy threshold, making such individual units 104A-B candidates for lighting adjustments due to reduced occupancy.

At step 516, the detected first indoor light level for each individual unit in the first set is compared to a first indoor light threshold. Such a comparison enables the control module 112 to identify a second set of individual units where the detected light level exceeds the desired threshold, indicating that the lighting intensity is higher than necessary for the occupancy level.

Finally, at step 518, the control module 112 reduces the amount of electrical power supplied to the clustered first light appliances 108 in each individual unit of the second set. Such reduction is carried out according to the control parameters assigned in step 510, ensuring that lighting appliances operate efficiently and consume only the necessary amount of power. Such an adjustment results in optimized energy usage across the building 102, particularly in individual units 104A-B that are under-occupied or where the lighting exceeds required levels for detected conditions.

Such a method facilitates energy savings by dynamically adjusting the power supplied to light appliances based on both occupancy and lighting conditions in real time, reducing wastage and improving the overall energy efficiency of the building's lighting system.

In an embodiment, the control parameters assigned to each cluster of mapped first light appliances 108 are dynamically adjusted based on factors such as outdoor light level, weather conditions, instant time and power consumption. Such dynamic adjustment enables real-time energy optimization by considering environmental and operational conditions. Further, such adjustment improves energy efficiency within the building 102.

In another embodiment, the control module 112 adjusts the electrical power supplied to clustered first light appliances 108 based on current electricity rates. Such adjustment of supplied electrical power enables cost-effective energy management by reducing power consumption during peak electricity pricing periods.

In another embodiment, first light appliances 108 within each cluster are categorized based on parameters such as light source type, energy rating, power consumption, fixture type and light output. Such categorization enables the system to fine-tune control strategies for different types of light appliances. Further, such categorization enhances energy savings.

Further disclosed is a non-transitory computer-readable storage medium comprising executable instructions that, when executed by a processing system including a processor, perform the energy management method. The method comprises detecting the first indoor light level, determining the occupancy level, scanning the first light appliances 108, grouping the appliances into clusters, assigning control parameters, receiving the detected light and occupancy levels, comparing them with respective thresholds and reducing the electrical power supplied to the appliances accordingly. The method implemented on such a medium ensures that energy management is carried out effectively, reducing energy waste and improving building 102 sustainability.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A building energy management system (BEMS) for a building comprising a plurality of individual units, wherein each individual unit comprises:
a first light detector to detect a first indoor light level for each individual unit, wherein the detected first indoor light level is associated with light emitted from a plurality of first light appliances arranged within the individual unit; and
a first occupancy sensor to determine a first occupancy level within the individual unit;
and wherein the BEMS comprises a control module connected to each first light detector, the plurality of first light appliances and each first occupancy sensor, wherein the control module:
scans to determine a list of all the first light appliances within each individual unit to create a map of the first light appliances;
groups the mapped first light appliances into a plurality of clusters based on predefined criteria;
assigns control parameters to each cluster;
receives the detected first indoor light level from the first light detector of each individual unit and the determined first occupancy level for each individual unit;
compares the determined first occupancy level with a first occupancy threshold for each individual unit to identify a first set of individual units having the determined first occupancy level lower than the first occupancy threshold;
compares the detected first indoor light level with a first indoor light threshold for each individual unit of the first set of individual units to identify a second set of individual units having the detected first indoor light level higher than the first indoor light threshold; and
controls, by reducing the amount of electrical power supplied to the clustered first light appliances within each individual unit of the second set of individual units according to the assigned control parameters.

2. The BEMS as claimed in claim 1, wherein the building comprises a plurality of common areas and an outdoor space and wherein each common area and the outdoor space comprises:
a second light detector to detect a second light intensity for each common area and the outdoor space, wherein the detected second light intensity is associated with light emitted from a plurality of second light fixtures arranged within each common area and the outdoor space; and
a second occupancy sensor to determine a second occupancy status for each common area and the outdoor space;
and wherein the control module is connected to each second light detector, the plurality of second light fixtures and each second occupancy sensor and wherein the control module:
scans to identify all the second light fixtures within each common area and the outdoor space to create an inventory of the second light fixtures;
groups the second light fixtures into a plurality of categories based on preset parameters;
assigns operational settings to each category;
receives the detected second light intensity and the determined second occupancy status for each common area and the outdoor space;
compares the determined second occupancy status with a second occupancy threshold for each common area and the outdoor space to identify a primary set of common areas and the outdoor space having the determined second occupancy status lower than the second occupancy threshold;
compares the detected second light intensity with a second light threshold for each common area and outdoor space of the primary set to identify a secondary set of common areas and the outdoor space having the detected second light intensity higher than the second light threshold;
utilizes the assigned operational settings to adjust an operation of the categories of the second light fixtures within the secondary set of common areas and the outdoor space; and
controls, by reducing the amount of electrical power supplied to the plurality of second light fixtures within each common area and the outdoor space of the secondary set according to the assigned operational settings.

3. The BEMS as claimed in claim 2, wherein the control module automatically sorts the added or removed second light detector, at least one second light appliance and the second occupancy sensor based on at least one condition, wherein the condition is selected from: a device type, an internet protocol (IP) address associated with the device, a device name and a device status.

4. The BEMS as claimed in claim 1, wherein each first light detector is implemented using a photocell array.

5. The BEMS as claimed in claim 2, wherein each second indoor light detector is implemented using a second photocell array.

6. The BEMS as claimed in claim 1, wherein each first light appliance is connected to a first dimming driver and wherein the control module controls, individually, each first dimming driver to alter the amount of electrical power supplied to each first light appliance.

7. The BEMS as claimed in claim 2, wherein each second light appliance is connected to a second dimming driver and wherein the control module controls, individually, each second dimming driver to alter the amount of electrical power supplied to each second light appliance.

8. The BEMS as claimed in claim 2, wherein the BEMS comprises a memory to store operating information associated with each first light appliance and each second light appliance and wherein the operating information comprises historical information associated with increasing or decreasing the amount of electrical power supplied to the plurality of first light appliances and the plurality of second light appliances.

9. The BEMS as claimed in claim 8, wherein the memory stores scheduling information associated with each first light appliance and each second light appliance and wherein the scheduling information comprises command information associated with increasing or decreasing the amount of electrical power supplied to the plurality of first light appliances and/or the plurality of second light appliances at a particular time.

10. The BEMS as claimed in claim 9, wherein the memory stores functionality information associated with each first light appliance and each second light appliance and wherein the functionality information comprises failure information associated with the plurality of first light appliances and the plurality of second light appliances.

11. The BEMS as claimed in claim 2, wherein the BEMS comprises a plurality of input units connected to the control module and wherein each input unit receives a user input for modifying behavior settings associated with the plurality of first light appliances and the plurality of second light appliances.

12. A method for managing energy within a building comprising a plurality of individual units, wherein each individual unit comprises a plurality of first light appliances and wherein the method comprises:
detecting, using a first light detector in each individual unit, a first indoor light level corresponding to light emitted by the plurality of first light appliances within the individual unit;
determining, using a first occupancy sensor in each individual unit, a first occupancy level within the individual unit;
scanning, by a control module, the plurality of first light appliances in each individual unit to generate a list of the first light appliances for creating a map of the first light appliances;
grouping, the mapped first light appliances into clusters based on a predefined criteria;
assigning, the control parameters to each cluster of the mapped first light appliances;
receiving, the detected first indoor light level from each first light detector for each individual unit and the determined first occupancy level for each individual unit;
comparing, the determined first occupancy level to a first occupancy threshold for each individual unit, and identifying a first set of individual units having the determined first occupancy level lower than the first occupancy threshold;
comparing, the detected first indoor light level with a first indoor light threshold for each individual unit in the first set of individual units, and identifying a second set of individual units having the detected first indoor light level exceeding the first indoor light threshold; and
reducing, according to the assigned control parameters, the amount of electrical power supplied to the clustered first light appliances in each individual unit of the second set of individual units.

13. The method of claim 12, wherein the control parameters assigned to each cluster of the mapped first light appliances are dynamically adjusted based on at least one factor selected from: an outdoor light level, the weather conditions, an instant time and power consumption.

14. The method of claim 12, wherein the control module adjusts the electrical power supplied to the clustered first light appliances based on current electricity rate.

15. The method of claim 12, wherein the first light appliances within each cluster are categorized based on a type of light source, an energy rating, power consumption, a fixture type, an amount of light output.

16. A non-transitory computer-readable storage medium, comprising executable instructions that, when executed by a processing system including a processor, for managing energy within a building comprising a plurality of individual units, wherein each individual unit comprises a plurality of first light appliances, comprising:
detecting, using a first light detector in each individual unit, a first indoor light level corresponding to light emitted by the plurality of first light appliances within the individual unit;
determining, using a first occupancy sensor in each individual unit, a first occupancy level within the individual unit;
scanning, by a control module, the plurality of first light appliances in each individual unit to generate a list of the first light appliances for creating a map of the first light appliances;
grouping, the mapped first light appliances into clusters based on predefined criteria;
assigning, the control parameters to each cluster of the mapped first light appliances;
receiving, the detected first indoor light level from each first light detector for each individual unit and the determined first occupancy level for each individual unit;
comparing, the determined first occupancy level to a first occupancy threshold for each individual unit, and identifying a first set of individual units having the determined first occupancy level lower than the first occupancy threshold;
comparing, the detected first indoor light level with a first indoor light threshold for each individual unit in the first set of individual units, and identifying a second set of individual units having the detected first indoor light level exceeding the first indoor light threshold; and
reducing, according to the assigned control parameters, the amount of electrical power supplied to the clustered first light appliances in each Individual unit of the second set of individual units.
